(19) United States
(12) Patent Application Publication
(10) Pub. No.: US 2010/0213860 A1
(43) Pub. Date: Aug. 26, 2010

(54) HIGH-PRESSURE LAMP AND ASSOCIATED OPERATING METHOD FOR RESONANT OPERATION OF HIGH-PRESSURE LAMPS IN THE LONGITUDINAL MODE AND ASSOCIATED SYSTEM

(75) Inventors: Paul Braun, Meitingen (DE); Jens Clark, Ebersberg (DE); Roland Huettinger, Kaufering (DE); Patrick Mueller, Karlsfeld (DE); Klaus Stockwald, Germering (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/679,015

(22) PCT Filed: Aug. 19, 2008
(86) PCT No.: PCT/EP2008/060846

§ 371 Date: Mar. 19, 2010

(30) Foreign Application Priority Data
Sep. 21, 2007 (DE) 10 2007 045 071.2

(51) Int. Cl. H01J 61/33; H05B 41/24

(52) U.S. Cl. 315/246; 313/634

(57) ABSTRACT

A high-pressure discharge lamp may include an elongated ceramic discharge vessel, wherein an electrode projects into the discharge vessel in each end area, wherein the electrode is attached to a bushing arranged in a capillary tube, wherein the internal diameter is reduced to at most 85% of the internal diameter of the elongated ceramic discharge vessel in the end area, such that an end surface remains at the end of the vessel, which has an internal diameter of at least 15% of the internal diameter, wherein a gap of most 20 μm remains between the bushing and the inner wall of the capillary, wherein the ratio between the areas which are formed by the internal diameter of the capillary and the diameter of the end surface is in the range from 0.06 to 0.12.

### TECHNICAL FIELD

The invention relates to a high-pressure lamp and an associated operating method for resonant operation of high-pressure lamps in the longitudinal mode, and an associated system according to the precharacterizing clause of claim 1. These are high-pressure discharge lamps with a ceramic discharge vessel and with an aspect ratio of at least 2.5.

### PRIOR ART

U.S. Pat. No. 6,400,100 has already disclosed a high-pressure lamp and an associated operating method for resonant operation of high-pressure lamps in the longitudinal mode, and an associated system. This document specifies a method for finding the second longitudinal acoustic resonant frequency. This is based on the assumption that, when the frequency which excites the longitudinal mode is decreased continuously, the resonant frequency in the vertical burning position can be found by occurrence of a relative burning voltage increase in the lamp. It is self-evident that when using this method, the longitudinal frequency is found for a segregated arc state at the vertical resonance, and is then maintained. This frequency found in this way may, however, be considerably too high, depending on the filling composition of the metal-halide filling and the time at which the search procedure was carried out, as a result of which excitation of the acoustic resonance at the frequency found using the abovementioned method results in inadequate thorough mixing, and the segregation is not overcome sufficiently well. In addition, implementation in an electronic ballast is complex. Further documents which deal with reducing the segregation by deliberate excitation of the second longitudinal mode are, for example, US 2003/117075, US 2003/117085, US 2005/067975 and US 2004/095076. All of these documents make use of a ceramic discharge vessel having a high aspect ratio of at least 1.5, and which is cylindrical. The ends are straight or hemispherical.

EP-A 1 729 324 discloses a ceramic discharge vessel which has inclined end pieces and is operated in the resonant mode. This vessel shape is selected specifically for operation at acoustic resonance, and attempts to largely suppress segregation.

### DESCRIPTION OF THE INVENTION

One object of the present invention is to provide a high-pressure discharge lamp having a ceramic discharge vessel according to the precharacterizing clause of claim 1, which minimizes the acoustic power used for segregation suppression when operating at acoustic resonance.

This object is achieved by the characterizing features of claim 1. Particular advantageous refinements are specified in the dependent claims.

Operation at acoustic resonance is aimed at exciting one or more resonant modes which contain the second longitudinal resonance or are coupled to it. In particular, this means frequencies such as those referred to as the combination mode in US 2005/067975, that is to say a mode whose frequency is calculated in accordance with a rule, for example from the frequencies of the longitudinal and further azimuthal and/or radial resonance. In this case, it is possible, if required, to use amplitude modulation and, in particular, to use pulse-width modulation for clocking.

In particular, this provides capabilities to control the color of metal-halide lamps by means of clocked and/or structured amplitude modulation, for example in the form of pulse-width variation, possibly combined with pulse-level variation, with the lamp power level remaining constant.

This is based on the assumption that there is a narrow tolerance band for the internal length IL for a predetermined geometry of the discharge vessel. This represents that dimension of the lamp which defines the longitudinal acoustic resonances and which must be excited for any optimum thorough mixing of the arc plasma, particularly in a vertical burning position.

In the vertical burning position, the demixing results in major changes in the speeds of sound in comparison to the horizontal burning position, as a result of the demixing of the particles radiating in the plasma when vertical convection takes place.

Resonant operation results in particular from operation at a carrier frequency of the lamp current in the medium RF range. The carrier frequency corresponds approximately to the frequency of half the second azimuthal acoustic resonance when the lamp is in the normal operating state. The term carrier frequency always means either the frequency of the current signal or that of the voltage signal. In contrast, it is always the power frequency which governs the excitation of the acoustic resonance, and this is twice the excitation frequency of the current or voltage.

By way of example, one reference point is a geometry of the discharge vessel with a conical end shape for a 70 W lamp, with the carrier frequency being in the range from 45 to 75 kHz, typically 50 kHz, and with a sweep frequency preferably being applied as FM modulation to this carrier frequency, whose value is chosen from a range from 100 to 200 Hz. Amplitude modulation is advantageously applied to this mode and is characterized, for example, by at least one of the two parameters AM degree and time duration of the AM, that is to say a duty ratio and time-controlled AM depth, AM(t).

In detail, an aspect ratio (internal length/internal diameter of the discharge vessel) of at least 2.5, in particular IL/ID=2.5-5.5 is preferred for high-efficiency metal-halide lamps with a ceramic discharge vessel and a long internal length. In this case, the intensity of one or more longitudinal modes (preferably the second or fourth) is excited by medium-frequency to high-frequency AM operation, via the degree of amplitude modulation. In these modes, the filling is transported into the central area of the discharge vessel, and the filling distribution is therefore set along the arc in the discharge vessel. In particular, this is particularly important for lamps which are operated vertically or inclined (>55° inclination angle of the lamp). This varies composition of the vapor pressure as well as the spectral absorption of the deposited filling components. The modulation frequency (fundamental frequency of the AM) for excitation of the longitudinal modes is typically in the frequency range 20-35 kHz. FM (frequency modulation) with sweep modes in the range from about 100-200 Hz is carried out for this purpose, for a typical carrier frequency of 45-75 kHz.

Typical metal-halide fillings contain components such as DyJ3, CeJ3, CaJ2, CsJ, LiJ and NaJ and possibly also TlJ.

Various operating modes for stable setting of segregation suppression in lamps with a high discharge vessel aspect ratio have been described so far.

In particular, it is evident that purely cylindrical shapes of the discharge vessel even produce acoustic instabilities, because of the high resonator Q factor, and are therefore suitable only to a limited extent for said operation in some particularly highly suitable operating modes which use the second longitudinal acoustic resonance to suppress segregation—in particular when the frequency-modulated and amplitude-modulated RF current forms are used at the same time or are used sequentially in time, in particular frequency modulation alternating with fixed-frequency operation, see for example U.S. Pat. No. 6,184,633. Until now, electronic ballasts have had to use complicated and complex control mechanisms in order to cope with these instabilities.

A specific embodiment of the internal contour of the discharge vessel, and in particular of the electrode rear area, is now proposed, which can preferably be used for an operating mode which, at least at times, uses the second acoustic longitudinal resonant mode or the combination of this mode with the excitation of radial or azimuthal modes.

The proposed solution is particularly effective for discharge vessels having an aspect ratio AV of at least 2.5 and at most 8. In other words, this relationship is:

2.5≦IL/ID≦8. (1)

A range 4≦AV≦5.5 is particularly preferable. The aspect ratio is defined as the ratio of the internal length IL to the internal diameter ID(=2*IR) where IR=internal radius. However, in this case the internal radius IR relates only to a center part of the discharge vessel, which remains cylindrical.

An operating method is now preferably used which stabilizes the discharge arc by a sequential crossing, in the form of a ramp, over the second azimuthal acoustic resonance. This results in arc constriction in every burning position. The axial segregation is effectively cancelled out by stable excitation, at least at times, of an even-numbered resonance, preferably the second, fourth, sixth or eighth longitudinal resonance.

Capillary tubes are frequently used as attachments to the discharge vessel for passing electrodes through in ceramic high-pressure discharge lamps according to the prior art, in which the electrode systems are passed to the actual burner body. The configuration of the electrode systems in the form of segmented parts, generally with bushings composed of metal windings (composed of Mo or W/in some cases alloyed or doped) results in depressions, adjacent to the burner area and cavities in the electrode rear area in the bushing areas.

For the use of longitudinal standing sound waves in high-pressure lamps such as these, it has been found that cavities such as these represent damping elements in the area of the rear walls, which otherwise reflect the sound. This is evident from the fact that the acoustic damping of the standing longitudinal wave is increased when using enlarged depressions by means of metal windings of different length, which fill the capillary area to a different extent. A similar situation applies when using metal windings or cermet bodies which necessitate relatively large gap widths to the inner wall of the ceramic capillary, and thus enlarge the gap width in the capillary. Therefore, because of the attenuation, a relatively high acoustic power is required to effectively set a longitudinal acoustic resonance for segregation suppression, for example because of the need to increase the degree of amplitude modulation for an AM+FM sweep method. The increase in the acoustic power for segregation suppression leads to a reduction in the lamp efficiency by typically 4-7% of the lamp yield per 10% increase in the acoustic power introduction that is used to suppress segregation.

The invention relates to the configuration of the end area, in particular also of the bushing, in the area of the transition from the capillary to the burner interior.

It has been found that, with regard to the area of the capillary, the important factor is that at least the start of a constriction toward the inner wall of the capillary, with a gap width of at most 20 μm, is located within a section LSP, which corresponds to an axial length of four times the internal diameter IDK of the capillary and is adjacent to the end surface at the end of the burner interior. This constriction is used to overcome the attenuation. The required acoustic power component to set the segregation suppression can thus be minimized.

This can be achieved by using a suitably designed bushing which, as a front part on the discharge side, has a winding which is well-matched to the internal diameter of the capillary. Alternatively, the front part may also be a metallic cylindrical part, or a cylindrical part containing cermet. This may also be an integral part of the electrode. It has been found to be best for the front part to be seated with an external diameter DFR in the outlet area of the capillary and for the capillary in this case to end flat, or for the front part to at most be slightly recessed into the capillary, to be precise by no more than the axial length LSP which corresponds to four times the internal diameter IDK of the capillary.

The damping results are even better if the end area on the discharge side of the capillary is completely closed, to a greater or lesser extent. This can be achieved, for example, by an interference fit or soldering of the electrode system in the ceramic plugs during installation, as a result of which there is no longer any gap between the electrode system and the ceramic wall, at least at a constriction.

This makes it possible to achieve the lowest acoustic power for excitation of the longitudinal acoustic resonance that is necessary to ensure segregation suppression.

As a major second measure, it is necessary for the end area of the discharge vessel to be positioned transversely with respect to the axis of the discharge vessel, as a result of which it forms an end surface over a total length of 15% to 85% of the maximum internal diameter ID of the discharge vessel.

As a third major measure, it is necessary for the end of the discharge vessel to taper toward the end surface. A constriction is particularly preferable which has continuous concave curvature and thus, at best, ensures a laminar flow.

The pressure of the filling in the discharge vessel should preferably be chosen carefully in this case.

End area contours which taper the internal diameter approximately continuously and run obliquely with respect to the lamp axis, and therefore with respect to the direction in which longitudinal modes are formed, have been found to be advantageous. Three-dimensionally, this corresponds to a conical or funnel-shaped taper.

However, the end area transition contour may also be concave, that is say curved outward—for example in a hemispherical shape—or convex, that is to say curved inward—for example as a rotation surface of an ellipse section—and can then merge, for example from a constriction to 0.6*ID, again into an inner wall, which runs at right angles to the lamp axis, as an end surface. This may possibly be considered to be directly a transition into the capillary or a plug part. Two sections with different curvature, one concave and convex, are particularly preferably located one behind the other.

If the end area has a concave profile, the maximum radius of curvature KR should be equal to half the internal diameter IR=ID/2, and in the case of a convex or linearly running conical taper, the tangent at the inner end point of the end area should include an acute angle αe of at most 45° with the alignment of the center area parallel to the axis.

One example of a purely convex-curved end area is an internal contour shaped in the form of a trumpet bell, in particular an internal contour in the form of a section of a hyperboloid.

In particular, the damping is influenced to a major extent by a central zone of the end area of the length LRD, at a distance from the end of the internal volume which, seen from the end of the discharge vessel, extends at least between 0.40*LRD to 0.60*LRD. Here, the tangent angle at of the internal contour with respect to the axial direction, measured from the axis, should preferably be in the range between αt=15° and αt=45°. It is particularly preferably in the range between αt=25° and αt=35°.

One criterion for the specific choice of the profile of the internal contour of the end area is, in particular, the resonator Q factor for excitation of the second longitudinal acoustic resonance. The resonator Q factor must selectively reach a sufficiently high level for the excitation of the second longitudinal resonance 2L. The resonator Q factor can be derived from those power components in the power frequency spectrum which are required to excite the second longitudinal resonance. This typically occurs at about 5 to 20% of the lamp power in this area.

Depending on the operating mode, this also applies to the resonances which are coupled to this resonance, such as those which occur in mixed modes, for example radial-longitudinal or azimuthal-longitudinal resonances. Typical excitation modes are 1R+2L or 3AZ+2L. The most suitable contours are those which at the same time exhibit a considerably lower resonator Q factor for higher harmonics of the 2L, that is to say which attenuate them as much as possible.

Excellent conditions for the design of the internal contour of high-efficiency ceramic lamps for operation in the combined AM+FM mode are achieved with deliberate combined excitation of the second and possibly fourth longitudinal resonance and their combination with the longitudinal-radial resonance, while at the same time suppressing the eighth longitudinal resonance, and its resonance combinations, as much as possible.

The essential feature for this, is on the one hand, first of all the provision of a sufficiently large end surface at the resonator end, whose diameter IDE amounts to at least 15% of the cylindrical internal diameter ID. The internal diameter IDE should preferably amount to at least 20% of the cylindrical internal diameter ID.

The combination of the abovementioned acoustic resonances in the discharge vessel makes it possible to set improved acoustically produced, convection cell patterns, in increased pressure conditions, in the convection-governed arc plasma area, such that combinations of increased light yields of 120 lm/W or even more with a color reproduction Ra of more than 85 and typically 90, can be achieved over relatively long operating times of typically 4000 h-6000 h, with a good maintenance behavior.

It has been found that a constriction in the lamp internal contour in the end area of the discharge vessel over a length LRD is preferable:

LRD=0.095×IL to 0.155×IL, with a typical value being LRD=0.125×IL.

In this case, LRD is related to the overall internal length IL of the lamp and ends at an end surface with a reduced internal diameter IDE. These constraints are ideal for the production of a stable convection cell structure, which is produced via the standing acoustic wave field in the plasma gas, in order to achieve optimum thorough mixing of the arc plasma gas, thus allowing color demixing of the plasma to be completely suppressed in any desired lamp position.

The internal diameter of the lamp is preferably continuously reduced over the end area such that a transition from the approximately cylindrical center part with the internal diameter ID to the tapering end area opens in a concave radius R1 of the taper.

Preferably, ID/6≦R1≦ID/2. Typical values are 0.35 ID to 0.5 ID.

An area LRD of the constriction which, roughly speaking, is curved in an S-shape, is particularly preferable. The reduction in the internal diameter in this case merges into a convex radius R2 via a point of inflection starting from a concave radius R1, which radius R2 meets an end surface which runs at right angles to the lamp axis, with a resultant diameter IDE.

Preferably: ID/4≦R2≦ID. A typical value is R2=0.65 ID.

In particular, it has been found that the diameter of the end surface IDE should be in a range between 0.15 and 0.85 ID.

Particularly good results are achieved if this diameter IDE is suitably matched to the original internal diameter ID of the discharge vessel. Roughly speaking, the ratio between IDE and ID should become lower the larger ID is itself. The preferred guideline is that VID=IDE/ID=a×ID+b, where

a=−0.120 to −0.135, and where b=1.0 to 1.1.

In the case of cylindrical end shapes, the values of the resonator Q factor for 2L and higher harmonics such as 4L or 6L are comparable to one another. In the case of essentially cylindrical discharge vessels, this means that higher harmonic resonances which, for example, are excited in the case of amplitude modulation are initiated when moving through the acoustic second longitudinal resonance—because of the very high resonator Q factor. This results in the formation of additional acoustically defined convection cells which, in some circumstances can lead to sudden impedance changes and to quenching of the arc discharge. When moving through the second longitudinal resonant frequency fᵣₑₛ_{_{—}}_{2L} from a higher excitation frequency—typically from fₛₜₐᵣₜAM=fᵣₑₛ_{_{—}}_{2L}+5 kHz to fₛₜₒₚAM=fᵣₑₛ_{_{—}}_{2L}−5 kHz with a typical AM degree of 10-30%—major lamp impedance variations and an unsteady arc then occur leading to unstable lamp behavior. Undesirable arc unsteadiness can also be caused by setting the excitation frequency to a frequency in the vicinity of the lamp impedance variation that occurs to an increased extent.

This is associated with considerably fluctuating lamp impedance values with peak values which exceed 1.5 times the lamp impedance in the non-excited state. This can result in the lamp going out. It is therefore not possible to set a mode for stable improved suppression of segregation of the arc column when the lamp is in the vertical or inclined burning position.

This is achieved for the first time with the choice of the end shapes according to the invention. Moving through the second longitudinal resonant frequency from a higher excitation frequency—typically from fₛₜₐᵣₜAM=fᵣₑₛ_{_{—}}_{2L}+5 kHz to fₛₜₒₚAM=fᵣₑₛ_{_{—}}_{2L}−5 kHz with a typical AM degree of 15-35%—leads to the formation of stable arc shapes with suppression of the incidence of higher harmonic resonances. It exhibits a stable formation of two symmetrical arc constrictions at about ⅓ to ¼ and about ⅔ to ¾ of the internal length IL in the frequency range of the amplitude modulation frequency fAM between fAM=fᵣₑₛ_{_{—}}_{2L} up to typically fAM=fᵣₑₛ_{_{—}}_{2L}-1 kHz. If fAM is reduced further, the excitation of the second longitudinal resonance ends in a stable form without any arc instability, with the formation of two arc constrictions which are symmetrical with respect to the lamp center, to be precise with reproducible cut-off frequencies fAM_{end}.

### BRIEF DESCRIPTION OF THE DRAWINGS

The invention will be explained in more detail in the following text with reference to a plurality of exemplary embodiments. In the figures:

FIG. 1 schematically illustrates a high-pressure discharge lamp;

FIG. 2 schematically illustrates a discharge vessel of a high-pressure lamp;

FIGS. 3-7 illustrate various embodiments of the end of the discharge vessel;

FIG. 8 illustrates the schematic design of an electronic ballast;

FIGS. 9 and 10 illustrate the acoustic power and efficiency of a lamp such as this, and

FIG. 11 illustrates a further exemplary embodiment of the end of a discharge vessel.

### PREFERRED EMBODIMENT OF THE INVENTION

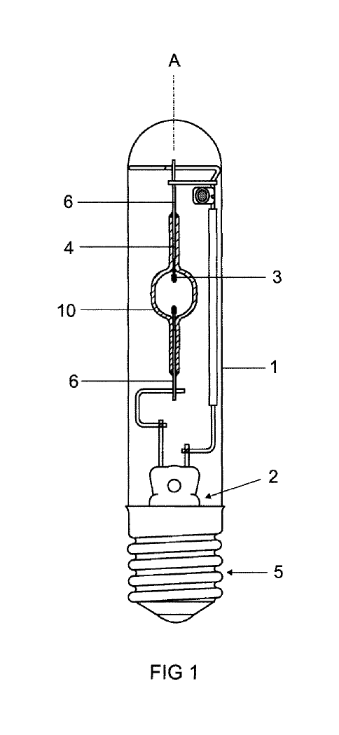

FIG. 1 schematically illustrates a metal-halide lamp with an outer bulb 1 composed of hard glass or quartz glass which has a longitudinal axis and is closed at one end by a plate seal 2. Two external power supply lines are passed to the exterior (not visible) at the plate seal 2, and end in a cap 5. A ceramic discharge vessel 10 which is sealed on two sides and is composed of PCA (Al₂O₃) with two electrodes 3 and a filling composed of metal halides is inserted axially into the outer bulb.

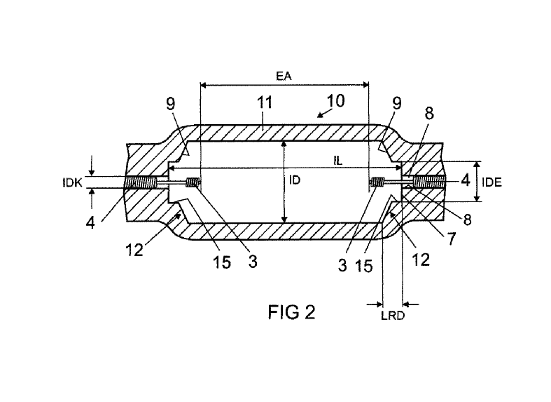

FIG. 2 shows a schematic illustration of the discharge vessel 10 with a relatively high aspect ratio ID/IL. The discharge vessel 10 has a cylindrical center part 11 and two ends 12, with a given internal diameter ID=2*IR, where IR is the internal radius, and a given internal length IL. Electrodes 3 are arranged at the ends 12 of the discharge vessel and are connected by means of bushings 4 to internal power supply lines 6 (see FIG. 1). Typically, the discharge vessel contains a filling of buffer gas Hg with argon and metal halides, for example a mixture of alkaline and rare-earth iodides and thallium.

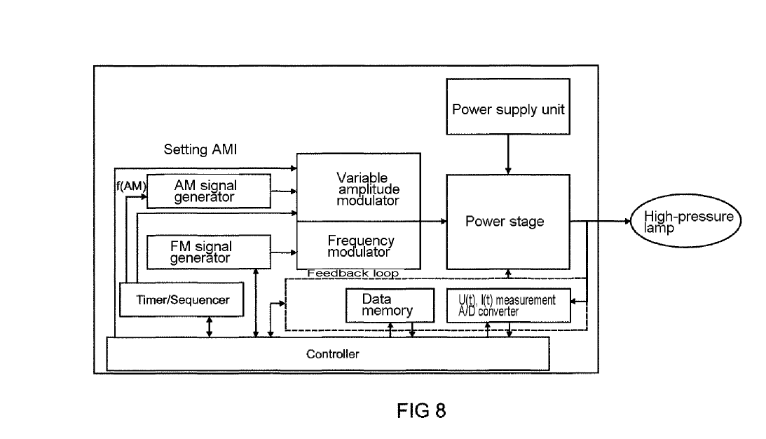

The lamp is operated using an electronic ballast, see FIG. 8, at high frequency at acoustically stabilized resonance. It is particularly worthwhile using the second longitudinal resonance or resonances associated with it for this purpose.

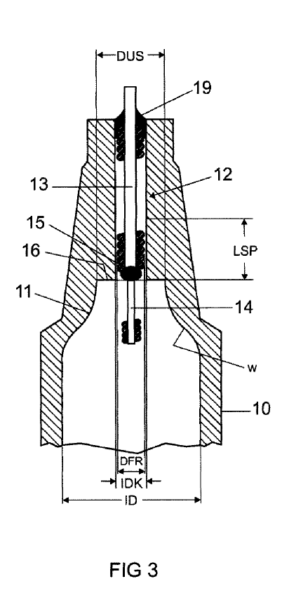

One specific exemplary embodiment is a ceramic discharge vessel 10 having a conical end area 11 and capillary 12 with an internal diameter IDK, having a bushing 13 in the form of a pin with a winding pushed thereon at the front, in this context see FIG. 3. The shank 14 of the electrode is welded to the pin, and the weld point is annotated 15. A narrow gap width=20 μm effectively remains for a winding diameter DFR=0.64 mm with respect to constant internal diameter of the capillary IDK=0.68 mm.

In this specific exemplary embodiment, the required acoustic power in order to achieve optimum segregation suppression in a range from fₒₚₜ to fₒₚₜ-1 kHz is approximately 10% of the total power. In other words, the width of the frequency band for optimum segregation suppression is at least 1 kHz.

If, in contrast, the winding diameter is chosen to be DFR=0.55 mm with the design data otherwise being the same and with the same filling, the required acoustic power is about 18% to 20% of the total power.

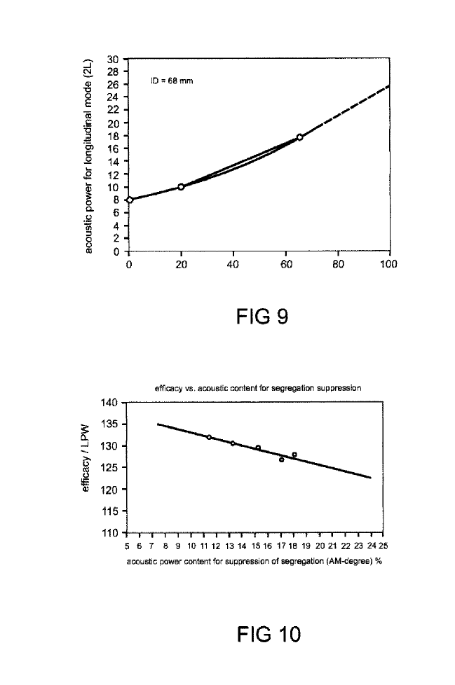

With a completely flush closure, that is to say a gap width of 0 or DFR=IDK, only 8% of the acoustic power is required, see FIG. 9.

In compliance with the above technical teaching, an efficiency improvement from, for example 125 LPW to 135 LPW can be achieved for high-efficiency lamps, see FIG. 10.

The geometric relationships are typically chosen according to Table 1, which shows the wattage of the discharge vessel (first column). IDK, the diameter of the hole in the capillary, is indicated in the second column.

TABLE 1

| | | | End surface | | Ratio (%) of |
|---|---|---|---|---|---|
| | | Max. ID | diameter | Ratio | the IDK/end |
| Wattage | IDK (μm) | burner | (DUS) | DUS/ID | surface areas |
| 20 W | 500 | 2 mm | 1.7 mm | 0.85 | 8.7 |
| 35 W | 500 | 2.7 mm | 1.9 mm | 0.7 | 7.0 |
| 70 W | 680 | 4 mm | 2.4 mm | 0.6 | 8.0 |
| 150 W | 850 | 6 mm | 2.6 mm | 0.43 | 10.7 |

Column 3 shows the maximum internal diameter ID of the discharge vessel. Column 4 shows the diameter of the end surface (DUS) transversally with respect to the longitudinal axis of the discharge vessel. Column 5 shows the ratio between the diameter and the maximum internal diameter ID of the discharge vessel. This should be chosen to be relatively high for a low wattage, and it can be chosen to be considerably lower for high wattage. Finally, column 6 shows the ratio between the area of the hole in the capillary and the end surface. This ratio must be chosen in a range from 6 to 12% in order to keep the damping as low as possible.

The important factor is that the capillary is integral with the discharge vessel, in such a way that there is no additional transition in the form of a step or other interface. A separate capillary, inserted in a recessed form, would lead to additional destructive interference with the reflection of the sound waves and furthermore, would disturb the laminar flow. The end surface should therefore be as homogeneous as possible and should contain a capillary as a disturbance only in the center. The front end of the bushing can end in the capillary at a depth between 0 (that is to say the plane of the end surface) and a maximum of four times IDK. Minimum damping results when the depth is as shallow as possible. However, this results in the greatest thermal bridge. It is best to choose this insertion depth between one and four times IDK.

FIG. 3 shows a lamp end in which the maximum internal diameter ID of the discharge vessel is reduced in two sections to the start of the end surface 16. Best results are achieved when the first section, which is adjacent to ID, has concave curvature, and the second section, which is adjacent to the end surface, has convex curvature. In this case, in particular, the point of inflection between the two sections should in fact be located in the front section of LRD, facing the discharge. For flow reasons, the front section should preferably have a radius of curvature R1 which corresponds approximately, at least with an accuracy of 20%, to half the diameter ID. The radius of curvature R2 of the rear section should be chosen such that R1<R2, in particular such that R2=1.1 to 1.3 R1. The end surface has a diameter DUS. The capillary 12 is seated with a constant internal diameter IDK centrally in the end surface. The electrode has a head and a shank, which is welded to a bushing pin. A winding with a maximum external diameter DFR is seated on the bushing pin. The gap width is approximately 15-20 μm. The gap width behind the winding plays no role. A further winding is seated at the end of the capillary and is sealed by means of glass solder 19. The transition between the end surface and the second section should be rounded, that is to say as far as possible without an edge.

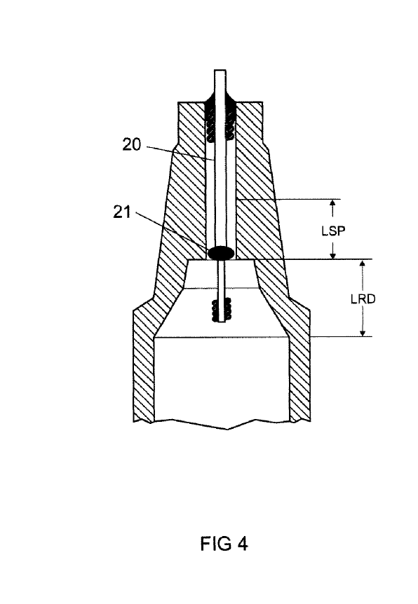

FIG. 4 shows a pin 20, composed of tungsten as a bushing, which has no winding at the discharge-side end. Instead of this, only a thickened weld point 21 is seated there, whose constriction is of such a size that the maximum diameter of the weld bead within the length LSP leaves only a gap of about 10 μm to the inner wall of the capillary. The weld bead is located close to the start of the capillary.

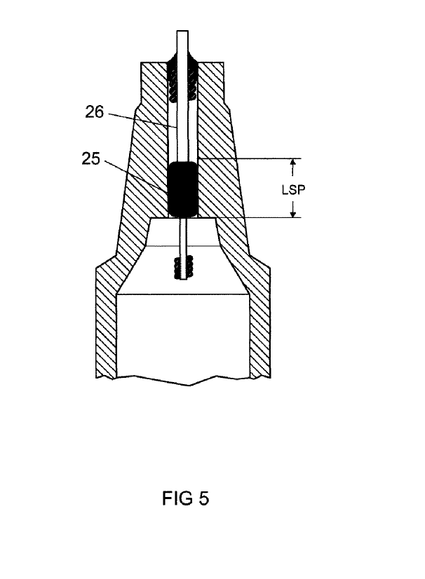

FIG. 5 shows a filling part 25, containing cermet, as the front part of the bushing. A pin 26 composed of Mo and with a considerably smaller diameter is seated behind this. In this case as well, the gap width between the filling part and inner wall of the capillary is very small, and is in the order of magnitude of 10 μm, to be precise over a length of virtually the entire length LSP.

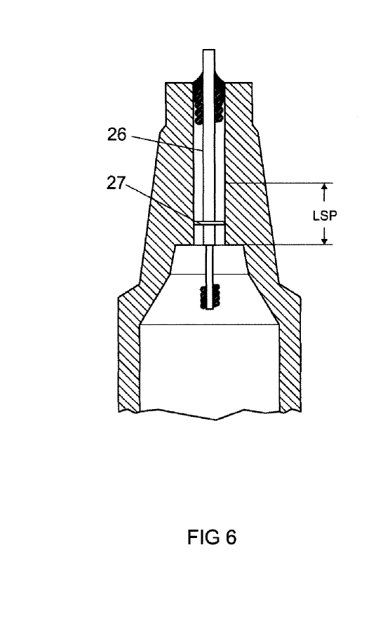

FIG. 6 shows a further exemplary embodiment, in which the narrow gap is provided only by a disk 27 which is fitted transversely on or before the pin 26 of the bushing. The disk is made of Mo, W or an alloy which contains Mo or W, and has a thickness of a few tenths of a millimeter.

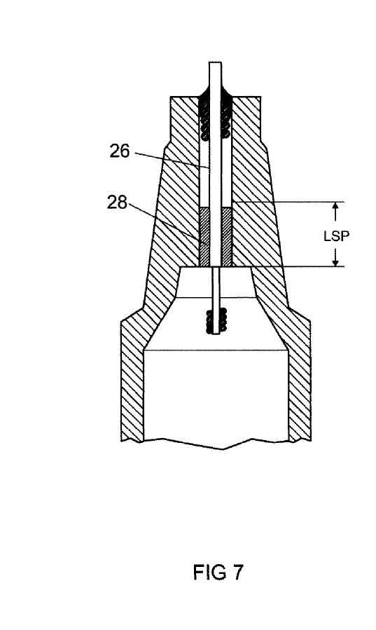

Finally, FIG. 7 shows an exemplary embodiment in which a considerable proportion of LSP is closed by a suitable material or by an interference fit or soldering of the electrode. In this case, the gap width is therefore zero. By way of example, this is a plug 28 composed of suitable material such as glass frit, fused ceramic or hard-solder material, or Pt alloy. Specific examples are fused ceramics from the Al203, Y203, and Ce203 system.

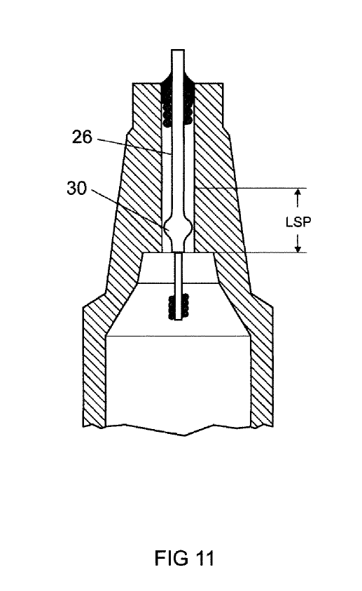

FIG. 11 shows a further exemplary embodiment, in which the bushing (or the electrode shank) has a thickened area 30 in the area LSP, which is an integral component of the bushing and projects out of the bushing. A bushing or electrode such as this can be produced by means of laser processing, for example.

The following exemplary embodiment will be explained in more detail in terms of operation at acoustic resonance.

One exemplary embodiment is a high-efficiency metal-halide lamp with a power of 70 W. The discharge vessel has a maximum axial internal length IL of 18.7 mm and an internal diameter ID of 4 mm. The aspect ratio is therefore 4.7. The high-pressure lamp is filled with 4.4 mg of Hg and a metal-halide mixture comprising NaI:CeI3:CaI2:TlI=1.78:0.28:1.93:0.28 mg. The electrode distance EA is 14.8 mm.

Initial investigations have shown that arc-stabilized operation is possible, with the arc being centered on the electrode connecting line in the vertical and horizontal burning positions. This is based on the assumption of operation with swept high frequency in the range from 45-55 kHz and a typical sweep rate of fFM=130 Hz.

In the vertical burning position, after the start of operation and after a warming up phase of about 120 sec a segregated, that is to say demixed, metal-halide distribution is evident along the arc. The metal-halide component in the vapor phase is not distributed uniformly over the arc length. The emission of the alkaline and SE iodides is concentrated in the lower third of the lamp, while emission of Hg and Tl is mainly observed in the upper part up to the upper electrode. In this state, the lamp has relatively poor color reproduction and a relatively low light yield. Furthermore, the color temperature in the vertical burning position differs significantly from that in the horizontal burning position, to be precise by up to 1500K.

The application of amplitude modulation at a fixed frequency fAM of about 25 kHz with an AM degree of 10-30% results in the production, corresponding to the schematic FIG. 12 (small figure shows the actual measurement), of an electrical power spectrum in the lamp with a sweep rate of 130 s−1, that is to say over a time period of 7.7 ms, in a range from 20 to 150 kHz. The power component in the region of the AM frequency (25 kHz) excites the second acoustic longitudinal resonance f002.

Higher orders are successfully suppressed. The virtually exclusive excitation of the second longitudinal acoustic resonance requires the lamp to have an adequate Q factor as a cavity resonator (so-called resonator Q factor). This Q factor can be characterized by the power component in the spectral range of the electrical power spectrum that is used for excitation that is required for a stable maintenance of the second longitudinal acoustic resonance in the vertical burning position. This value is typically at least about 10 to 20% of the lamp power. However, this minimum value should be adequately exceeded, for stable operation. In order to keep fluctuations in the lamp characteristics of a relatively large number of lamps as small as possible, a value of about 15 to 25% of the lamp power is therefore recommended.

One suitable operating method for high-pressure discharge lamps such as these uses resonant operation, using a radiofrequency carrier frequency, which is frequency-modulated in particular by means of a sweep signal (FM), and which is at the same time amplitude-modulated (AM), wherein a fundamental frequency is first of all defined for the AM wherein the fundamental frequency of the AM f_{2L} is derived from the second, longitudinal mode.

In this case, after the lamp has been ignited and a waiting time has been allowed to elapse, the color temperature is set at a predetermined power such that the amplitude modulation changes periodically between at least two states.

The frequency of the sweep signal can be derived from the first azimuthal and radial modes. In particular, a controller can set the fundamental frequency of the AM signal.

Particularly good results are achieved by using an AM degree for excitation of the second longitudinal acoustic resonance of 10 to 40%, in particular 10 to 25%. The exciting AM frequency is advantageously chosen to be between f_{2L} and f_{2L}−2 kHz.

In principle the amplitude of a fixed AM degree can change in steplike fashion, abruptly, gradually or in a manner which can be differentiated with a specific periodicity.

A typical operating method is based on operation at a carrier frequency in the medium HF range from 45 to 75 kHz, typically 50 kHz, to which a sweep frequency is preferably applied as FM modulation whose value is chosen from a range from 100 to 200 Hz. Amplitude modulation is applied to this operation, characterized by at least one of the two parameters AM degree and time duration of the AM, that is to say a duty ratio and time-controlled AM depth, AM(t). If required, the AM and its manipulation can be carried out only after a warming-up phase. The AM degree is defined as

AM degree=(Amax−Amin)/(Amax+Amin). In this case A is the amplitude.

In addition to the method, the invention covers ballasts in which the described procedures are implemented.

In detail, an aspect ratio (internal length/internal diameter) of the discharge vessel of at least 2.5, in particular IL/ID=4−5.5, is preferred for high-efficiency ceramic metal-halide lamps with a long internal length. In this case, the intensity of one or more longitudinal modes (preferably the second) is excited by medium-frequency to high-frequency AM operation by means of the amplitude modulation degree. In these modes, the filling is transported into the central area of the discharge vessel and of the plasma, thus setting the filling distribution in the discharge vessel along the arc, and counteracting segregation effects. In particular, this is particularly important for lamps that are operated vertically or inclined (preferably more than 55° inclination angle). This varies the composition of the vapor pressure as well as the spectral absorption of the deposited filling components. The modulation frequency (fundamental frequency of the AM) for excitation of the longitudinal modes is typically in the frequency range from 20-35 kHz. Frequency modulation (FM) with sweep modes in the range from about 100-200 Hz is carried out for a carrier frequency of typically 45-75 kHz.

Both the AM degree on its own and the time duration of the AM frequency modulated onto the carrier can be used for control purposes, in the sense of pulse times and pause times. The color temperature can be varied within wide ranges, with a high light yield and with a constant lamp power, by means of these parameters AM degree and duty ratio, that is to say the ratio between the time T in which the AM is switched on and the time in which the AM is switched off, or T(AM-on)/T(AM-off) for short, and, furthermore a time-controlled variable amplitude modulation depth AM(t), that is to say a superstructure of the AM degree.

FIG. 8 shows an outline circuit diagram of an associated electronic ballast, which has the following essential components:

Time/sequencer: this is where the time sequencing monitoring is carried out in order to control the time duration of the warming-up phase and onset of the application phase after ignition and after the arc occurs in the high-pressure lamp. The sweep rate for the lamp arc stabilization is also controlled here.

Furthermore, the scan rate as well as the time of holding at the respective frequency point when passing through frequency scans as well as the definition of pause times between successive procedure steps are controlled.

Power stage (power output stage): full-bridge or half-bridge with current-limiting elements and a typical frequency response. This is coupled to the power supply unit via a supply rail (450 V DC).

Feedback loop: identification that the lamp is operating, possibly with feedback of lamp parameters such as lamp current and lamp voltage in order to adjust the control parameters, and definition of the warming-up and application phase, as well as repetition of application phases with other matching parameters.

A circuit part is implemented here for sufficiently accurate measurement of the current and voltage at the electronic ballast output (lamp). The measured values for processing in the controller are processed further by this circuit part, via an A/D converter. The acquired data is written to a data memory, for further evaluation procedures.

Lamp: high-pressure discharge lamp (HID lamp)
FM modulator: high-power frequency modulator
AM modulator: analog variable high-power modulator with the capability to monitor both the frequency fAM and the AM degree AMI.
AM signal generator: digital or voltage-controlled oscillator
FM signal generator: digital or voltage-controlled oscillator
Power supply: rail voltage generator
Controller: central monitoring of all units
In principle: the operation is carried out using a high-frequency carrier frequency which, in particular, is frequency-modulated by means of a sweep signal (FM) and which is at the same time amplitude-modulated (AM), with a fundamental frequency of the AM first of all being defined, with the fundamental frequency of the AM f2L being derived from the second, longitudinal mode. In particular, the color temperature for a predetermined power is set after ignition of the lamp and after a waiting time has elapsed, in that the amplitude modulation is periodically changed between at least two states.

In this case, the frequency of the sweep signal is advantageously derived from the first azimuthal and radial modes.

1. A high-pressure discharge lamp which is intended for resonant operation with longitudinal acoustic resonances, comprising: an elongated ceramic discharge vessel, which defines a lamp axis and which has an internal volume with an internal length and a maximum internal diameter, and which is subdivided into a center area with a constant internal diameter and two end areas with a reduced internal diameter, wherein an electrode projects into the discharge vessel in each end area, wherein the electrode is attached to a bushing which is arranged in a capillary tube with a constant internal diameter at the end of the discharge vessel, wherein the discharge vessel has an aspect ratio of 2.5 to 8 wherein the internal diameter is reduced to at most 85% of the internal diameter of the elongated ceramic discharge vessel in the end area, such that an end surface remains at the end of the discharge vessel including the capillary, which has an internal diameter of at least 15% of the internal diameter of the elongated ceramic discharge vessel,
wherein a gap of most 20 μm remains between the bushing and the inner wall of the capillary over an axial length of at least twice the internal diameter of the capillary,
wherein the ratio between the areas which are formed by the internal diameter of the capillary and the diameter of the end surface is in the range from 0.06 to 0.12.

2. The high-pressure discharge lamp as claimed in claim 1, wherein the end area tapers toward the end surface such that it comprises a concave section and a convex section.

3. The high-pressure discharge lamp as claimed in claim 1, wherein the transition between the end area and the end surface is rounded.

4. The high-pressure discharge lamp as claimed in claim 1, wherein the bushing comprises a plurality of parts,
wherein a winding comprising Mo/W core pin and Mo/W winding is provided as a front part of the bushing, while maintaining a medium gap width of ≦20 μm.

5. The high-pressure discharge lamp as claimed in claim 1, wherein the bushing comprises a plurality of parts,
wherein a solid metallic cylindrical part or a cylindrical part containing cermet is provided as the front part of the bushing.

6. The high-pressure discharge lamp as claimed in claim 1, wherein the input area of the capillary is held without a gap, wherein an interference fit or soldering of the electrode is provided.

7. The high-pressure discharge lamp as claimed in claim 1,
wherein the discharge vessel has a filling which has metal halides.

8. An operating method for resonant operation of a high-pressure discharge lamp, using a radiofrequency carrier frequency, which is frequency-modulated in particular by means of a sweep signal (FM), and which is at the same time amplitude-modulated (AM),
the high-pressure discharge lamp comprising:
an elongated ceramic discharge vessel, which defines a lamp axis and which has an internal volume with an internal length and a maximum internal diameter, and which is subdivided into a center area with a constant internal diameter and two end areas with a reduced internal diameter,
wherein an electrode projects into the discharge vessel in each end area, wherein the electrode is attached to a bushing which is arranged in a capillary tube with a constant internal diameter at the end of the discharge vessel, wherein the discharge vessel has an aspect ratio of 2.5 to 8, wherein the internal diameter is reduced to at most 85% of the internal diameter of the elongated ceramic discharge vessel in the end area, such that an end surface remains at the end of the discharge vessel including the capillary, which has an internal diameter of at least 15% of the internal diameter of the elongated ceramic discharge vessel,
wherein a gap of most 20 μm remains between the bushing and the inner wall of the capillary over an axial length of at least twice the internal diameter of the capillary,
wherein the ratio between the areas which are formed by the internal diameter of the capillary and the diameter of the end surface is in the range from 0.06 to 0.12,
wherein the method comprises:
a fundamental frequency is first of all defined for the AM wherein the fundamental frequency of the AM is derived from the second, longitudinal mode.

9. The operating method as claimed in claim 8, wherein after the igniting of the lamp and waiting for a waiting period, the color temperature is set at a predetermined power in that the amplitude modulation changes periodically between at least two states.

10. The operating method as claimed in claim 8, wherein the frequency of the sweep signal is derived from the first azimuthal and radial modes.

11. The operating method as claimed in claim 8, wherein an AM degree for excitation of the second longitudinal acoustic resonance of 10 to 40% is used.

12. The operating method as claimed in claim 8, wherein the exciting AM frequency is between the value of the fundamental frequency of the AM and the value of the fundamental frequency of the AM—1 kHz.

13. The operating method as claimed in claim 8, wherein the amplitude of a fixed AM degree changes in a manner selected from a group consisting of; steplike fashion; abruptly; gradually; and in a manner which can be differentiated with a specific periodicity.

14. A system, comprising:
a high-pressure discharge lamp; and
an electronic ballast,
the high-pressure discharge lamp comprising:
an elongated ceramic discharge vessel, which defines a lamp axis and which has an internal volume with an internal length and a maximum internal diameter, and which is subdivided into a center area with a constant internal diameter and two end areas with a reduced internal diameter,
wherein an electrode projects into the discharge vessel in each end area, wherein the electrode is attached to a bushing which is arranged in a capillary tube with a constant internal diameter at the end of the discharge vessel, wherein the discharge vessel has an aspect ratio of 2.5 to 8, wherein the internal diameter is reduced to at most 85% of the internal diameter of the elongated ceramic discharge vessel in the end area, such that an end surface remains at the end of the discharge vessel including the capillary, which has an internal diameter of at least 15% of the internal diameter of the elongated ceramic discharge vessel,
wherein a gap of most 20 μM remains between the bushing and the inner wall of the capillary over an axial length of at least twice the internal diameter of the capillary,
wherein the ratio between the areas which are formed by the internal diameter of the capillary and the diameter of the end surface is in the range from 0.06 to 0.12,
wherein the electronic ballast is configured to provide an operating method for resonant operation of the high-pressure discharge lamp, using a radiofrequency carrier frequency, which is frequency-modulated in particular by means of a sweep signal (FM), and which is at the same time amplitude-modulated (AM),
wherein the method comprises:
a fundamental frequency is first of all defined for the AM wherein the fundamental frequency of the AM is derived from the second, longitudinal mode.

15. The high-pressure discharge lamp as claimed in claim 1,
wherein the discharge vessel has an aspect ratio of 3 to 6,

16. The high-pressure discharge lamp as claimed in claim 1,
wherein the internal diameter is reduced to at most 60% of the internal diameter of the elongated ceramic discharge vessel in the end area.

17. The high-pressure discharge lamp as claimed in claim 1,
wherein the capillary has an internal diameter of at least 20% of the internal diameter of the elongated ceramic discharge vessel.

18. The operating method as claimed in claim 11,
wherein an AM degree for excitation of the second longitudinal acoustic resonance of 18 to 25% is used.
